(19) United States
(12) Patent Application Publication
(10) Pub. No.: US 2006/0278456 A1
(43) Pub. Date: Dec. 14, 2006

(54) Fat tire adapter kit for motorcycle

(76) Inventor: Denis Desrosiers, Causapscal (CA)

Correspondence Address: MARIO D. THERIAULT, 812 HWY. 101 NASONWORTH, FREDERICTON, NB, E3C 2B5, CA

(21) Appl. No.: 11/329,291

(22) Filed: Jan. 11, 2006

Related U.S. Application Data
(60) Provisional application No. 60/684,228, filed on May 25, 2005.

(51) Int. Cl. B62K 11/00

(52) U.S. Cl. 180/219

(57) ABSTRACT

The adapter kit comprises an oversize fender that has a pair of longitudinal grooves in a central segment thereof. The fender is wider than a spacing between the frame beams extending rearward in a motorcycle frame. The fender is mounted between the frame beams with each groove partly enclosing one of the frame beams. Each groove is a subtraction of a projection of one of the frame beams from the shape of the fender such that the frame beams are fitly integrated into the central segment of the fender. In other aspects, the adapter kit also comprises a pair of frame extension stubs mountable to the frame beams and a pair of accessory mounting plates mountable to the frame extension stubs for retaining OEM accessories to the frame beams. In yet a further aspect, the kit has a swing arm with a brake caliper support bracket removably affixed thereto.

This application claims the benefit of U.S. Provisional Application No. 60/684,228, filed May 25, 2005.

### FIELD OF THE INVENTION

This invention pertains to customizing kits for installing a fat tire on a motorcycle, and more specifically it pertains to a kit containing an oversize fender for installation in the original frame of a motorcycle.

### BACKGROUND OF THE INVENTION

For many, a ride on a motorcycle is an escape from the stress of a job. It is also a timeout from the rules and regulations in one's life. In this sport, it is quite acceptable to let go with conformities, and to show individuality. Many do so by customizing their motorcycles to set them apart from the showroom models. Common images given to motorcycles are those of glamour and performance. In the first cases, bikers express themselves through beautiful paint jobs and added chrome. In the second cases, modifications are done to the engines, the mufflers and by widening the rear wheels.

In regard to wide rear wheels, there are several customizing kits available in the prior art to install a large tire on a motorcycle. For examples, the following US patents, the first of which had been granted to the inventor of the present invention, provide a good inventory of these kits and a chronology of their developments:
U.S. Pat. No. 5,996,718 issued to Denis Desrosiers on Dec. 7, 1999;
U.S. Pat. No. 6,230,837 issued to William Soileau on May 15, 2001;
U.S. Pat. No. 6,575,260 issued to Joseph R. Bourget on Jun. 10, 2003;
U.S. Pat. No. 6,755,272 issued to Henry Friesen on Jun. 29, 2004.

Although the customizing kits of the prior art deserve undeniable merits, the instructions available with these kits as well as from the prior art in general do not provide any assistance to someone who wants to install a wide fender on a motorcycle without modifying the frame of that motorcycle.

When installing a wider rear tire on a motorcycle, it is important to maintain the integrity of the frame of the motorcycle. When the frame is cut, widened and welded, the alignment of the wheels may be affected. The mounting of the engine, of the seat, the attachment of the hardware for supporting the saddle bags and the mufflers may also have to be modified to fit the widened frame. Also, many accessories from the original equipment manufacturer (OEM) no longer fit the motorcycle frame.

On an original FLH™ or FLT™ series Harley-Davidson™ motorcycle, for example, the frame thereof has two parallel and spaced-apart tubular members extending rearward behind the driver seat. These tubular frame members are referred to herein as the frame beams. The original rear wheel fender normally fits between these frame beams. These frame beams also support the trunk, the passenger seat, the back rest and the saddle bags of the motorcycle. When the spacing between the frame beams is changed, the equipment mounted to these frame beams must also be changed to accommodate the wider spacing.

As such, there is a need in this market for a wide fender that can be installed over a large tire without modifying the frame of the motorcycle, and especially without changing the spacing between the frame beams.

### SUMMARY OF THE INVENTION

In the present invention, however, there is provided an adapter kit for installing a fat tire and an oversize fender on a motorcycle without modifying the frame of the motorcycle. More particularly, there is provided an adapter kit for installing a fat tire and fender on a Harley-Davidson™ motorcycle, manufactured under one of the models in the FLH™ or FLT™ series. Basically, the adapter kit contains a swing arm, a rear axle, a drive shaft extension including associated transmission parts and spacers, a pair of frame beam extension stubs, an oversize fender, and tour pack and muffler support hardware.

More specifically, the present invention comprises an oversize fender that has a shape to fit within the original motorcycle frame, and a pair of frame extension stubs to which is fastened all the hardware required for supporting without modifications, an OEM passenger seat, saddle bags, backrest, trunk, and the mufflers of the motorcycle.

In one aspect of the present invention, the fender has a curved outline, a central segment and a pair of spaced-apart grooves along the central segment. The spaced-apart grooves are formed in a surface of the fender and have shapes for enclosing portions of the frame beams on a motorcycle frame, and for retaining the fender between the frame beams in their original configuration.

In another aspect of the present invention, there is provided a fender mounted to the frame of a motorcycle. The fender is wider than a spacing between the frame beams extending rearward on a motorcycle frame. The fender has a pair of longitudinal grooves in a central segment thereof, and each groove is a subtraction of a projection of one of the frame beams from the shape of the fender. Each groove encloses a portion of a frame beam such that the frame beams are fitly integrated into the central segment of the fender.

In another aspect of the present invention, each groove has an approximate half circle cross-section with an open side, and the open sides of both grooves are facing away from each other at about an obtuse angle there-between. The fender is thereby positively retained to the frame beams in both vertical and lateral directions.

In yet another aspect of the present invention the fender has a pair of notches across the flanges thereof extending tangent from the inside edge of a front segment thereof and into the grooves mentioned above. The notches provide a path for inserting the fender between the frame beams of a motorcycle without bending the fender.

In yet a further aspect of the present invention, there is provided an adapter kit for customizing a motorcycle with a fat tire. The adapter kit comprises a rear wheel fender which is wider than a spacing between the frame beams extending rearward on a motorcycle frame. The fender has a pair of grooves in a central segment thereof. The fender is mountable between the frame beams with each of the grooves partly enclosing one of the frame beams. The kit also comprises a pair of frame extension stubs mountable to the end of the frame beams and into the mentioned grooves. There are also provided a pair of accessory mounting plates respectively mountable to one of the frame extension stubs. Standard motorcycle accessories can be supported without modification to these plates.

The adapter kit also comprises a swing arm mountable to a motorcycle frame and having a brake caliper support bracket removably mounted thereto. The removable caliper support bracket is advantageous for allowing the removal of the rear wheel from the swing arm without having to deflate the rear tire.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

One embodiment of the present invention is illustrated in the accompanying drawings, in which like numerals denote like parts throughout the several views, and in which:

FIG. 1 is a perspective rear view of a touring motorcycle having a fat tire mounted thereon, and an oversize fender substantially as described herein after;

FIG. 2 is a partial perspective view of a motorcycle frame, showing the frame beams thereof;

FIG. 3 is a partial exploded view of a frame beam and a frame extension stub;

FIGS. 4, 5 and 6 illustrate a top, side and end views respectively of a frame extension stub;

FIG. 7 shows a perspective rear and left side view of a preferred fender;

FIG. 8 shows a perspective front and left side view of the preferred fender and the mounting hardware therefor;

FIG. 9 shows a front view of the preferred fender;

FIG. 10 is an enlarged view of the right side groove in the preferred fender as seen in detail circle 10 in FIG. 9 and showing a cross-section of the groove taken across the longitudinal axis of the fender at about a mid-point along the groove;

FIGS. 11 and 12 are a top view and a left side view respectively of the preferred fender;

FIGS. 13 and 13A are cross-section views of two preferred fenders as seen along the vertical axis thereof;

FIGS. 14, 15 and 16 illustrate a partial motorcycle frame and the preferred fender in three different positions, representing a preferred installation sequence for installing the preferred fender in a motorcycle frame;

FIG. 17 is a partial perspective side view of a motorcycle frame showing fender mounting hardware;

FIG. 18 is a partial perspective side and rear view of a motorcycle frame showing the preferred fender installed therein;

FIGS. 19 and 20 show perspective left and right side views respectively of the modified swing arm used to install a fat tire on a motorcycle;

FIGS. 21, 22 and 23 show an isometric view, a left side view and an end view respectively of a preferred brake caliper support bracket.

### DESCRIPTION OF THE PREFERRED EMBODIMENT

While this invention is susceptible of embodiment in many different forms, there is shown in the drawings and will be described in details herein one specific embodiment of a fender and other accessories to mount a wide tire on a motorcycle. The present disclosure is to be considered as an example of the principles of the invention and is not intended to limit the invention to the embodiment illustrated and described.

Although efforts have been made to limit the use of precise dimensions and exact geometric qualifiers, some narrow expressions remain in this disclosure and are used for convenience only to provide a better understanding of the present invention. Such dimensions and shapes can vary from one model of motorcycle to the other, and from one size of tire to another in a same model of motorcycle. Therefore the dimensions and geometric expressions mentioned herein should not be considered as being absolute.

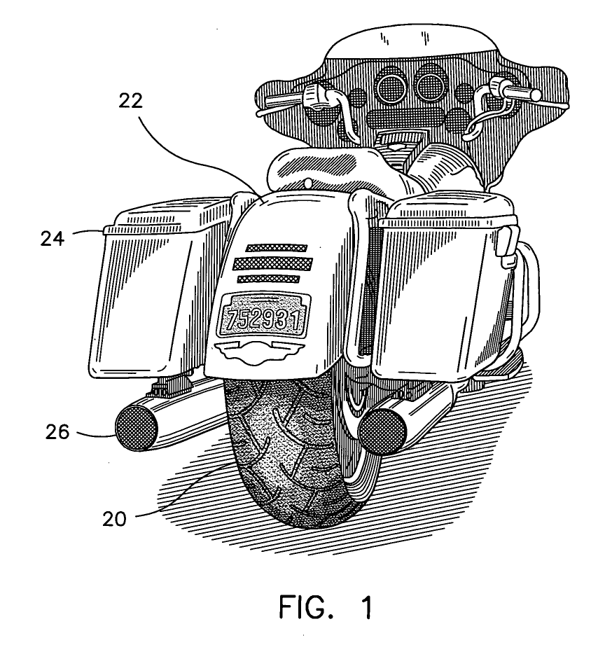

Referring to FIG. 1, a rear view of a Harley-Davidson™ FLHT standard™ motorcycle is illustrated therein. This motorcycle has been customized with a wide rear tire 20 and an oversize fender 22 according to the preferred embodiment of the present invention. Although a wide tire 20 is installed on this motorcycle, the saddle bags 24 and the mufflers 26 are mounted at their same lateral positions as on the original motorcycle.

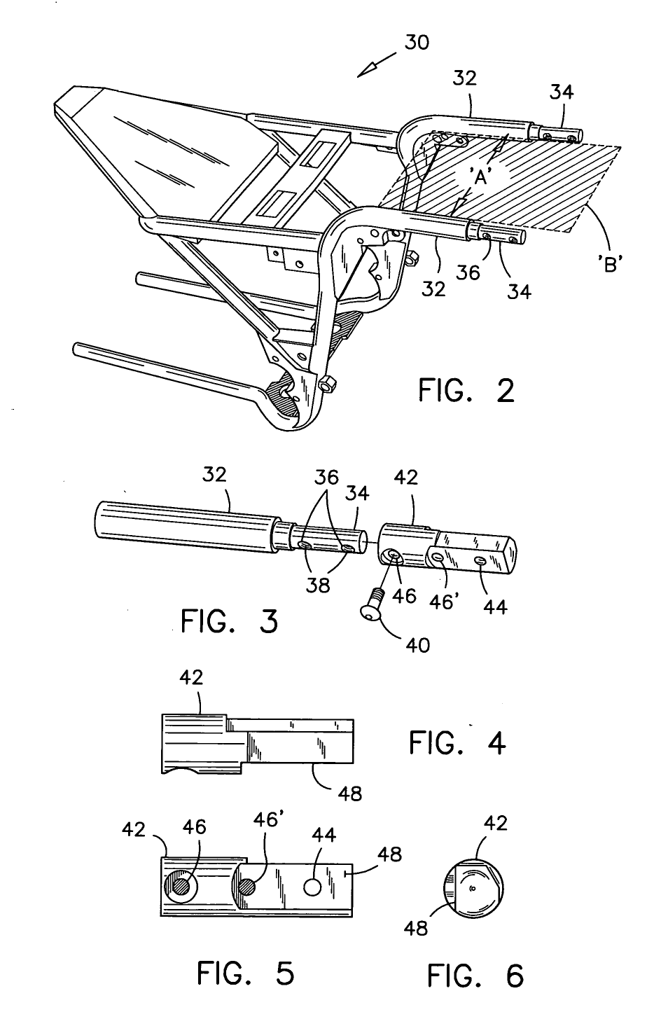

Referring now to FIG. 2, the rear end of a frame 30 of a FLH™ or a FLT™ series Harley-Davidson™ motorcycle is illustrated therein. The frame beams extending alongside an original rear fender are labelled as 32. These frame beams 32 are spaced apart a distance ‘A’. These frame beams 32 have cylindrical cross-sections and define a horizontal plane ‘B’ there-between, which plane ‘B’ will be referred to hereinafter to describe the structure of the preferred fender 22.

Each frame beam 32 has a spigot 34 at the rear end thereof and that spigot 34 has a smaller diameter as compared with the remaining portion of the beam. Each of these spigots 34 has two horizontal holes 36 therein and the hardware to support the rear end accessories of the motorcycle are originally supported by means of through bolts mounted in these holes 36.

In order to advantageously utilize the space between and under the frame beams 32, the holes 36 are drilled out, tapped and threaded inserts are mounted in each hole 36. The threaded inserts 38 are preferably the type known under the trade-mark of Helicoil™. Accordingly, the original through bolts are replaced by screws 40.

A pair of frame extension stubs 42 are mounted to the ends on the frame beams 32. Each of these frame extension stubs 42 has a hollow cylindrical front portion (not shown) and a solid rear portion having a substantially polygonal cross-section. The front portion has an inside diameter that is substantially a tight sliding fit over the diameter of one of the spigots 34.

Each stub 42 has a threaded hole 44 through its diameter in the solid portion thereof, and two plain holes 46,46′ extending radially through the wall of the hollow portion thereof. The holes 46,46′ and 44 are parallel and evenly spaced-apart from each other. Both holes 46, 46′ coincide with the threaded holes 36 in the spigot 34 when the stub 42 is mounted on one of the spigots 34. The foremost plain hole 46 is used to receive the first screw 40, and the second and third holes 46′, 44 are used to receive similar screws 40 for retaining a mounting plate (shown elsewhere). These mounting plates are used to retain the hardware supporting the rear end of the oversize fender 22, the mufflers and other accessories, at substantially a same location on the motorcycle as these accessories were mounted on the original motorcycle frame. Each frame extension stub 42 has a flat surface 48 thereon extending across both rearmost holes 46′, 44 and perpendicular to these holes. This surface 48 has a length to receive the aforesaid mounting plate.

The screw (shown elsewhere) that is mounted in the intermediate hole 46′ is threaded into the rearmost threaded insert 38 in the spigot 34. The screw (shown elsewhere) that is mounted in the hole 44 is threaded in that hole.

It will be appreciated that both stubs 42 are mirror images of each other and the one illustrated in FIGS. 3-6 is the left-side stub 42.

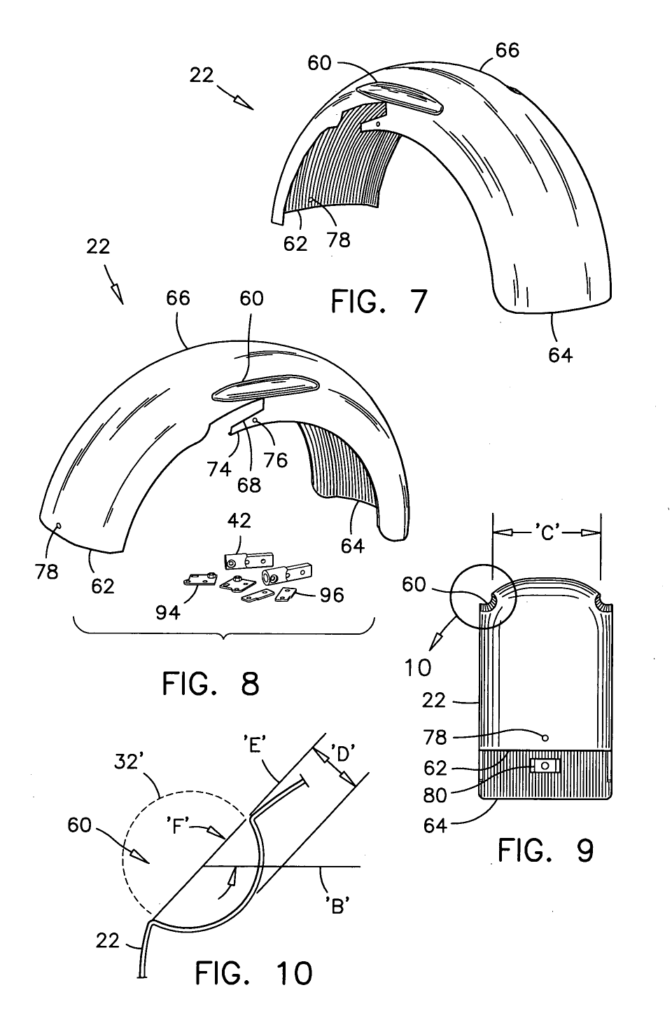

Referring now to FIGS. 7-12, the oversize fender 22 according to the preferred embodiment of the present invention is illustrated therein in five different views. The oversize fender 22 has two longitudinal cylindrical grooves 60 formed therein to engage over and to partly enclose the frame beams 32. Both longitudinal cylindrical grooves 60 are formed on the central segment of the fender 22.

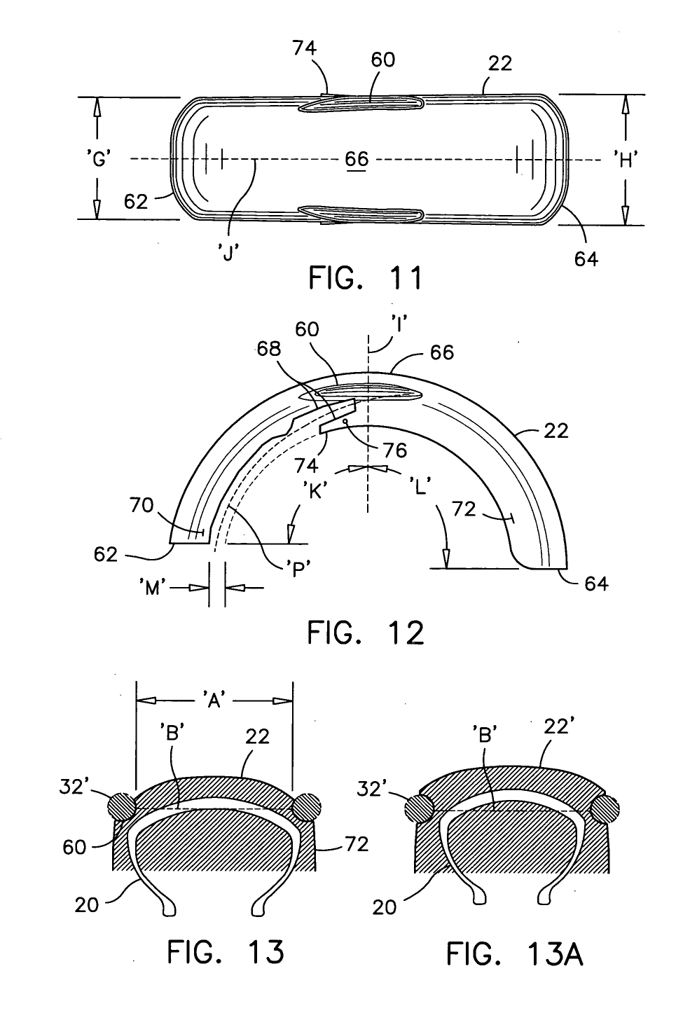

Referring particularly to FIGS. 9 and 10, these longitudinal grooves 60 have approximate half-circle cross-sections, are mounted back-to-back and extend along a respective side of the fender 22. The transverse curvature of each groove 60 is approximately a sliding fit over the diameter of a frame beam 32 and of a frame extension stub 42. The spacing ‘C’ between the grooves 60 is substantially a sliding fit between the tubular frame beams 32, or a same dimension as the spacing ‘A’ between the tubular frame beams 32. In use, the grooves 60 engage over the frame beams 32 and the frame extension stubs 42, for retaining the fender 22 to the frame of the motorcycle.

Preferably, each of these grooves 60 has a depth ‘D’ which is a similar dimension as the radius of a cross-section of one of the frame beams 32. Preferably, each of the grooves 60 has an open side along a plane ‘E’ that makes an angle ‘F’ of between about 45° or slightly less and about 90° or slightly more with plane ‘B’ such that the fender 22 is integrated into the motorcycle frame 30 and is retained to the frame beams 32 in both a vertical and lateral directions. The variations in the angle ‘F’ is best understood when making reference to FIGS. 13 and 13A. Two models of fenders 22 and 22′ are illustrated therein. It will be understood from these illustrations that numerous other models of fenders can also be mounted between the frame beams 32 of a motorcycle when applying the instructions presented herein.

The screws 40 retaining the stubs 42 to the spigots 34 and the pair of screws 40 retaining additional hardware to the frame extension stubs 42, do not extend through the stubs 42, such that the surfaces of the stubs 42 engaging the longitudinal grooves 60 do not have any protrusion thereon, and such that the stubs 42 can be fitly slid into the grooves 60.

Advantageously, the tire space defined under the oversize fender 22 extends above the horizontal plane ‘B’ defined by the frame beams 32 and outside of the width ‘A’ between the frame beams 32. As can be seen in FIGS. 9, 10, 13 and 13A, the preferred cross-section of one of the grooves 60 is a subtraction of a projection 32′ of one of the frame beams 32 from the shape of the fender 22 or 22′. Such precise fit provides a better and more aesthetically pleasing mounting of the oversize fender to the frame beams 32, and leaves more room under the fender 22 or 22′ for the oversize tire 20.

Referring again the FIGS. 7-10, while looking at FIGS. 11 and 12, the preferred fender 22 has a front end 62 and a rear end 64. The width ‘G’ of the fender 22 at the front end 62 is slightly less than the width ‘H’ at the rear end 64. In the preferred fender 22 for a FLH™ or FLT™ series Harley-Davidson™ motorcycle, the difference in width between ‘G’ and ‘H’ is about one-half inch.

The oversize fender 22 has a curved cross-section and a slightly elliptical outline extending approximately a half circle when seen from the side. The fender 22 has a vertical axis ‘I’ extending substantially from a centre of the elliptical outline mentioned above. Both longitudinal grooves 60 extend similar distances on both sides of this vertical axis ‘I’ along the outside central segment of the fender. The longitudinal grooves 60 extend substantially parallel with a longitudinal axis ‘J’ of the fender when seen from the side, and in slightly converging alignments when seen from the top of the fender 22.

The fender 22 also has a top portion 66 between the front and rear ends 62, 64. The front inside segment ‘K’ of the fender 22 has flanges 70 that have a lesser depth than the flanges 72 on the rear inside segment ‘L’, as indicated by the dimension ‘M’ in FIG. 12. The front inside segment ‘K’ has dimensions to fit into the original frame of the motorcycle. The rear inside segment ‘L’ has a width ‘H’ and depth to accommodate a tire that is wider than the one originally installed by the manufacturer of the motorcycle.

The top portion 66 of the fender 22 has notches 68 on both sides thereof. The notches 68 extend substantially tangent from the edges of the flanges 70 on the front segment ‘K’ and merge into the lower edge of a respective groove 60, near the vertical axis ‘I’ of the fender 22. Each notch 68 and the adjoining edge of a respective flange 70 define a circular path ‘P’ along which the fender 22 is aligned during its installation between the frame beams 32 of a motorcycle, as will be explained later.

Each notch 68 defines a lateral tab 74 extending forward from a respective rear flange 72, relative to the vertical axis ‘I’. Both lateral tabs 74 have mounting holes 76 therein. The front end 62 of the fender 22 also has a mounting hole 78 therein. Similarly, the rear end 64 of the fender 22 has a mounting bracket 80 affixed to an inside surface thereof.

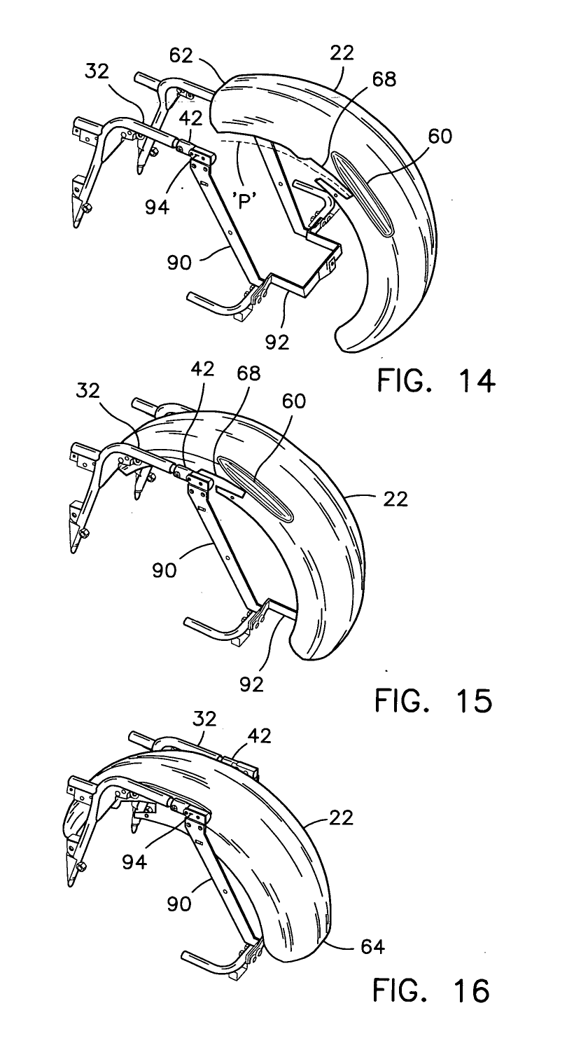

Referring now to FIGS. 14-16, a preferred method for installing the fender 22 between the frame beams 32 of a motorcycle will be explained. The fender 22 is positioned with the front end 62 thereof between the frame beams 32, and with the frame beams 32 aligning substantially along the circular path ‘P’. Then, the fender 22 is rotated and moved forward, keeping the frame beams 32 substantially aligned with the circular path ‘P’, and until the frame extension stubs 42 slide into, and reach the end of, the longitudinal grooves 60.

The support braces 90 retaining the rear end 64 of the fender are the original braces supplied with the original motorcycle. The fender support cross bar 92, may be extended slightly to accommodate the difference in length between the original and the new fender, but otherwise remains substantially the same as the one supplied on the original motorcycle.

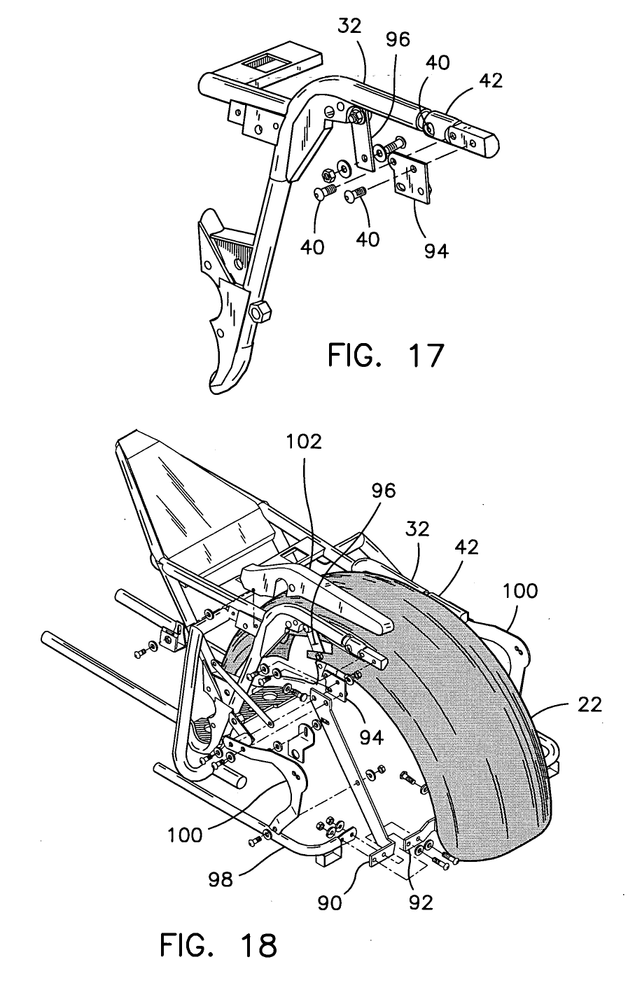

Each support brace 90 is fastened to a frame extension stub 42 by means of a mounting plate 94, as mentioned before, and screws 40 extending in one of the threaded inserts 38 and into the threaded hole 44 as can be understood from the previous description of the frame extension stub 42 and from the illustration in FIG. 17. Also referring to this last drawing, and to FIG. 18, one can understand that the fender 22 is also supported by a pair of flat bars 96 extending from under the frame beams 32 and into the holes 76 in the lateral tabs 74.

Referring to FIGS. 8 and 18, the customizing kit according to the present invention comprises an oversize fender 22, a pair of new extension stubs 42, new mounting plates 94 and new flat bars 96. Preferably, the customizing kit also comprises a modified fender support cross bar 92, modified bag support bars 98, modified rear docking plates 100, modified strut covers 102, and other hardware and fasteners that are not mentioned herein for not being the focus of the present invention. The modifications made to the latter parts 92, 98, 100, and 102 are only minor and should be apparent to those skilled in the art. These modifications include slight variations in these parts to cooperate with the locations of the mounting plates 94 and the increased length of the new fender 22 basically.

More importantly, the fender 22 in the preferred customizing kit is mounted to an original frame of a FLH™ or FLT™ series Harley-Davidson™ motorcycle without modification to the frame of that motorcycle. Therefore, the original saddle bags, the original passenger seat, the original trunk and passenger backrest and mufflers are mountable to the motorcycle at the same lateral locations as originally mounted on the original motorcycle. All OEM rear end accessories are also mountable to the customized motorcycle in a same way as on an original model.

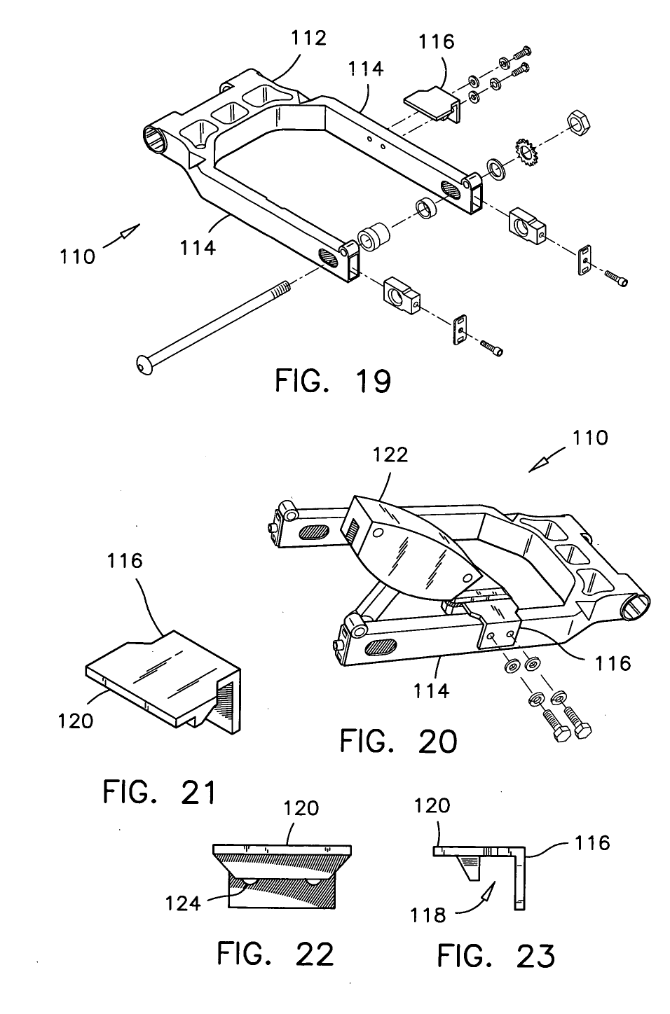

Referring now to FIGS. 19-23, the customizing kit according to the preferred embodiment also comprises a wide swing arm 110 as illustrated in these drawings. The front portion 112 of this wide swing arm 110 is preferably machined from mild steel to which are welded both hollow arms 114. It has been found that this machined and welded structure is easier to manufacture and is more structurally stable than an all-welded structure.

An important element on this wider swing arm 110 is a bolt-on brake calliper support bracket 116. This support bracket 116 is bolted to the arm 114 of the swing arm 110 and is easily removed for removing the rear wheel. Because of this removable caliper support bracket 116, it is possible to remove the rear wheel without deflating the rear tire.

The caliper support bracket has a saddle portion 118 with dimensions to fitly mount to one of the arms 114 of the swing arm 110, and a blade portion 120 which extends inside the swing arm 110. The blade portion 120 has dimensions to engage into a corresponding slot in the brake caliper 122. The caliper support bracket 116 has two mounting holes 124 therein through which bolts are inserted to retain it to the arm 114.

As to other manner of usage and operation of the present invention, the same should be apparent from the above description and accompanying drawings, and accordingly further discussion relative to the manner of usage and operation of the invention would be considered repetitious and is not provided.

While one embodiment of the oversize fender and adapter kit according to the present invention has been illustrated and described herein above, it will be appreciated by those skilled in the art that various modifications, alternate constructions and equivalents may be employed without departing from the true spirit and scope of the invention. For examples, the oversize fender according to the preferred embodiment of the present invention may be mounted on a motorcycle that is different from the models specified herein. Therefore, the above description and the illustrations should not be construed as limiting the scope of the invention which is defined by the appended claims.

What is claimed is:

1. A fender having a curved outline and means for attachment to a motorcycle frame comprising a pair of spaced-apart grooves in a surface thereof having means for enclosing portions of said frame.

2. The fender as claimed in claim 1, further comprising a central segment and a longitudinal axis and wherein said grooves extend along said central segment parallel with said longitudinal axis.

3. The fender as claimed in claim 1, wherein said grooves have a same transverse curvature.

4. The fender as claimed in claim 3, wherein each of said grooves has an open side and said open sides facing away from each other.

5. The fender as claimed in claim 4 wherein said open sides are facing away from each other at an obtuse angle there-between.

6. The fender as claimed in claim 1 further comprising a front and rear segments, front side flanges enclosing said front segment and rear side flanges along said rear segment, said front side flanges being defined by a first radius relative to said curved outline, said rear side flanges being defined by a second radius relative to said curved outline, and said first radius being larger than said second radius.

7. The fender as claimed in claim 6, wherein said front segment has a first width and said rear segment has a second width and said second width is larger than said first width.

8. The fender as claimed in claim 7, wherein said front side flange has an inside edge relative to said curved outline, and further comprising a pair of notches in said front side flanges wherein each of said notches extends tangent from said inside edge and into one of said grooves.

9. The fender as claimed in claim 8, wherein each of said notches extend into one of said grooves near a midpoint along said groove.

10. The fender as claimed in claim 8, wherein each of said notches defines a tab along each of said rear side flange and said tab has a mounting hole therein.

11. In combination, a motorcycle frame and a fender mounted to said motorcycle frame; said motorcycle frame having a pair of spaced-apart frame beams extending rearward; said fender being wider than a spacing between said frame beams; said fender being mounted between said frame beams; said fender having a pair of longitudinal grooves in a central segment thereof wherein each of said grooves is a subtraction of a projection of one of said frame beams from a shape of said fender; and each of said grooves encloses a portion of one of said frame beams such that said frame beams are fitly integrated into said central segment of said fender.

12. The combination as claimed in claim 11, wherein each of said frame beams has a circular cross-section and a diameter, and each of said grooves has a circular cross-section and a transverse curvature wherein said transverse curvature is a sliding fit over said diameter.

13. The combination as claimed in claim 12, wherein each of said grooves has an open side, and said open sides facing away from each other at about an obtuse angle there-between.

14. The combination as claimed in claim 11, further comprising a pair of frame extension stubs mounted to said frame beams and being respectively partly enclosed in one of said grooves.

15. The combination as claimed in claim 14, further comprising a pair of accessory mounting plates respectively affixed to one of said frame extension stubs.

16. An adapter kit for customizing a motorcycle comprising;
a rear wheel fender mountable to a motorcycle frame having a pair of spaced-apart frame beams extending rearward; said fender being wider than a spacing between said frame beams; said fender having a pair of grooves in a central segment thereof; said fender being mountable between said frame beams with each of said grooves partly enclosing one of said frame beams.

17. The adapter kit as claimed in claim 16, wherein said fender has flanges enclosing the sides thereof, and a pair of notches extending across said flanges and into said grooves.

18. The adapter kit as claimed in claim 16, further comprising a pair of frame extension stubs having means for mounting to said frame beams and into said grooves.

19. The adapter kit as claimed in claim 18 further comprising a pair of accessory mounting plates respectively mountable to one of said frame extension stubs, and having means thereon for supporting OEM motorcycle accessories thereto.

20. The adapter kit as claimed in claim 19, further comprising a swing arm mountable to said motorcycle frame; said swing arm having a brake caliper support bracket removably mounted thereto.
